(19) United States
(12) Patent Application Publication
(10) Pub. No.: US 2006/0165960 A1
(43) Pub. Date: Jul. 27, 2006

(54) Packaging material of the corrugated cardboard type

(76) Inventor: Tommy Rydberg, Habo (SE)

Correspondence Address: Donald S Dowden;Cooper & Dunham, 1185 Avenue of the Americas, New York, NY, 10036, US

(21) Appl. No.: 10/507,093

(22) PCT Filed: Mar. 6, 2003
(86) PCT No.: PCT/IB03/00832

§ 371 Date: Jul. 15, 2005

(30) Foreign Application Priority Data
Mar. 7, 2002 (DK) PA 2002-00347

(51) Int. Cl. B32B 1/00

(52) U.S. Cl. 428/174

(57) ABSTRACT

A packaging material of the corrugated cardboard type includes a laminate of at least one plane paper layer (1) and at least one auxiliary paper layer (3) with waves presenting an amplitude perpendicular to the plane of propagation of the auxiliary paper layer. The two layers are joined by means of a gluing material. The auxiliary paper layer (3) includes furthermore a system of substantially parallel waves (10, 10′, 10″), the amplitude of which is in the plane of propagation of the auxiliary paper layer (3). As a result, the packaging material is more stiff than hitherto known without the lightness and voluminocity of the material being affected. In addition, the material possesses an increased tear resistance and is very suited for being provided with prints.

### TECHNICAL FIELD

A packaging material of the corrugated cardboard type as stated in the preamble of claim 1.

### BACKGROUND ART

It is known to manufacture corrugated cardboard which includes a plane paper layer. A corrugated auxiliary paper layer is glued onto the plane paper layer, and the corrugations of said auxiliary paper layer present an amplitude perpendicular to the direction of propagation of the packaging material. All the ridges are arranged as rectilinear parallel corrugations. However, problems are involved in forming folding lines in the material as a folding along a specific line has a tendency to be staggered relative to the adjacent vales. In addition, a printing by means of raster on the plane paper layer implies due to the washboard effect that the printed colours opposite the ridges are of a slightly different tint than the colours opposite the wave. In addition, the tear resistance parallel to the waves is weak. The rigidity of the material and the capability of absorbing impacts of said material are not so good either as said material is not sufficiently stiff.

EP-A-0424526 (FIGS. 4 and 6) discloses a packaging material with only one auxiliary corrugated layer.

WO-A-071277 discloses a sheet and strip material with only one corrugated auxiliary layer.

U.S. Pat. No. 6,207,242 (FIG. 3) discloses a packing material with two auxiliary corrugated layers of the same type, the phase displacement between corresponding waves being 90° or

$$\frac{π}{2} .$$

U.S. Pat. No. 4,012,276 discloses a packaing material with two auxiliary corrugated layers of a different type, a wave phase displacement existing between said layers of a different type.

### BRIEF DESCRIPTION OF THE INVENTION

The object of the invention is to provide a packaging material of the above type which is more suited for being subjected to a printing than hitherto known, which is more stiff than hitherto known, and which presents an improved tear resistance.

The packaging material according to the invention is characterised in the features stated in the characterising clause of claim 1. The two auxiliary corrugated layers are of the same type. As a result, the packaging material becomes more stiff than hitherto known, viz flexurally rigid, without the lightness and voluminocity of the material being affected. The folding of such waves requires a considerable force. In addition, the material turned out to be highly suited for imprints. The tear resistance has been increased because the possibility of tearing up the material along a wave has been reduced. The folding lines are very distinct as they always extend across some ridges.

According to the invention, the plane paper layer and the auxiliary paper layer may be of the same thickness, preferably between 0.05 and 0.3 mm, and preferably be approximately 0.1 mm, where the auxiliary paper layer may be of a weight of 50 to 250 g/m², especially 70 to 150 g/m². The resulting packaging material is very durable.

Moreover, in the packaging material according to the invention a starch-based glue or cold-water glue maybe used for the lamination of the layers. Such a packaging material turned out to present a high cohesive power and a long durability.

According to the invention, the surface of each auxiliary paper layer may follow a face substantially corresponding to the functional expression:

$$z ( x , y ) = a sin ( \frac{2 π}{{λ}_{1}} x + \frac{π}{2} + b sin \frac{2 π}{{λ}_{2}} y )$$

where a and λ₁ represent the amplitude and the wavelength, respectively, of the waves perpendicular to the plane of propagation of the auxiliary paper layer, and where b and λ₂ represent the amplitude and the wavelength, respectively, of the waves in the plane of said auxiliary paper layer, the ratio

$$\frac{a}{b}$$

of the amplitudes for the two types of waves being be in the range of 0.10 to 0.60, preferably 0.15 to 0.50, especially 0.22 corresponding to a=0.5 mm and b=2.25 mm. This embodiment of the packaging material turned out to be particularly stiff and suited for transportation of large separate furniture parts and plates.

Furthermore, the ratio

$$\frac{{λ}_{1}}{{λ}_{2}}$$

of the wavelengths for the two types of waves may according to the invention be in the range of 0.09 to 0.20, preferably 0.15 corresponding to λ₁=3.5 mm and λ₂=23.5 mm This has proved particularly advantageous.

Finally, the waves of at least one type of waves may according to the invention be rather flat on the sides in such a manner that said waves are substantially serrated where the ridges and the grooves are slightly rounded, or the waves may be substantially square. As a result, an inexpensive manufacture of the auxiliary paper layer is obtained because the pressing tools used for pressing the auxiliary paper layer into shape can be manufactured at a lower price than hitherto known.

### BRIEF DESCRIPTION OF THE DRAWING

The invention is explained in detail below with reference to the drawing, in which

FIG. 1 is a perspective view of a portion of a packaging material according to the invention, where a small phase displacement appears between the waves presenting an amplitude perpendicular to the first auxiliary paper layer and the waves presenting an amplitude perpendicular to the second auxiliary paper layer, and

FIG. 2 discloses in an XYZ-coordinate system an ideal embodiment of the waves of an auxiliary paper layer,

### BEST MODE FOR CARRYING OUT THE INVENTION

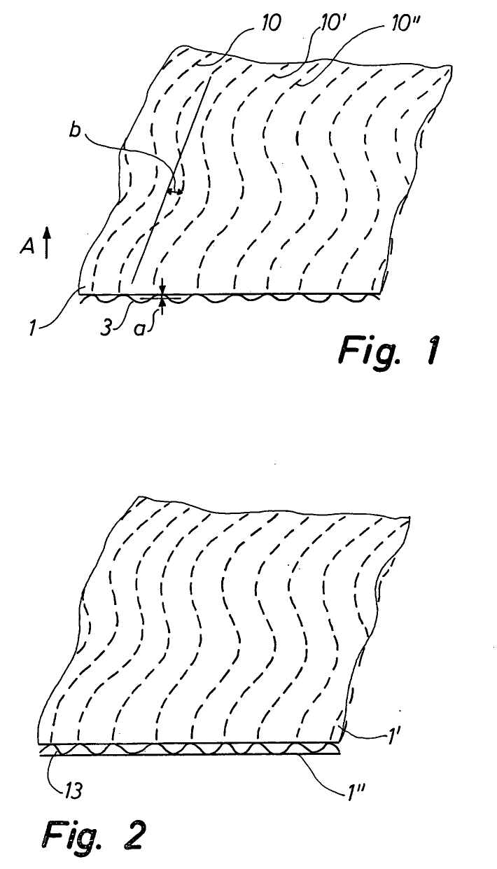

The portion of the packaging material shown in FIG. 1 is formed as a laminate including a plane paper layer 11 and an auxiliary paper layer 12 arranged below the layer 11. Below the auxiliary layer 12 there is arranged a second plane paper layer 13. Below the latter there is arranged a second auxiliary paper layer 14 and optionally a third plane paper layer 15. The auxiliary paper layers include waves presenting an amplitude a perpendicular to the plane of propagation of the auxiliary paper layer, viz. follow the direction parallel to the arrow A. The wave top of these waves form in the auxiliary paper layers 12 and 14 a system of substantially parallel waves presenting amplitudes b in the plane of propagnation of the auxiliary paper layers. The latter waves can also be called oscillating in parallel.

The plane paper layers 11 and 13 and the auxiliary paper layers 12 and 14 may be of the same thickness, preferably between 0.05 and 0.3 mm, such as 0.1 mm Each auxiliary paper layer can for instance be of a weight of 50 to 250 g/m², especially 70 to 150 g/m².

A glue, such as a starch-based glue or a cold-water glue, can for instance be used for the lamination of the layers.

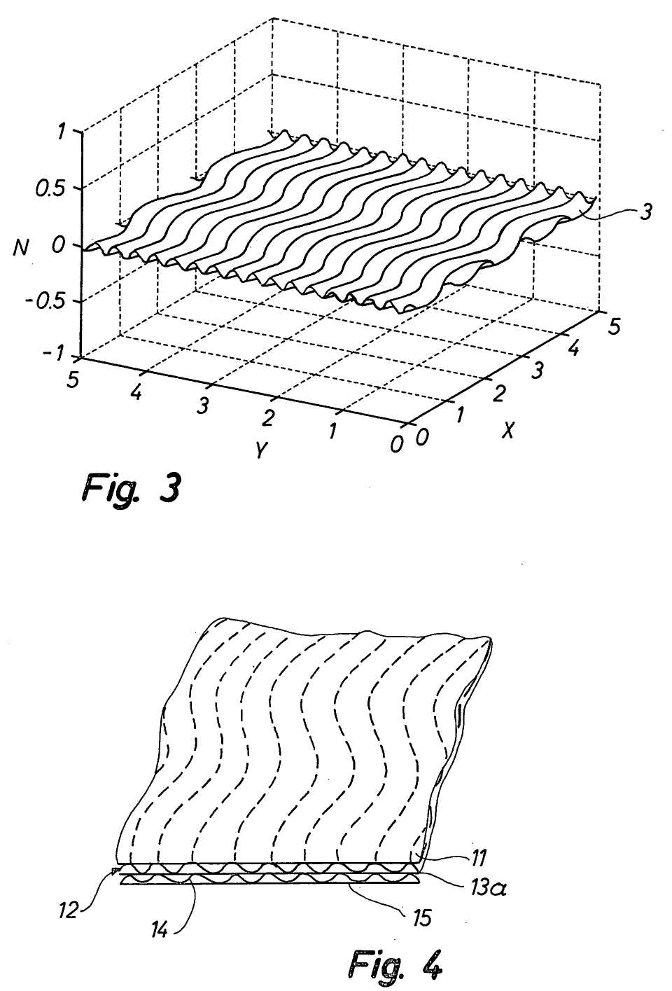

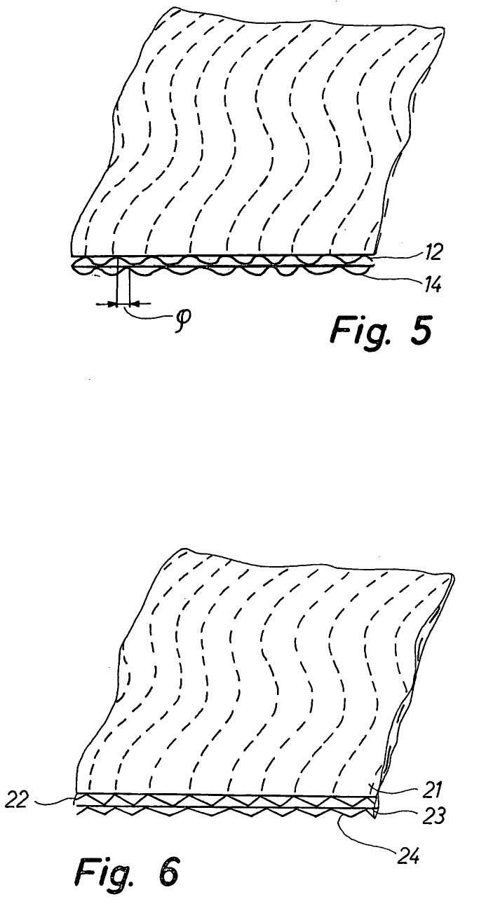

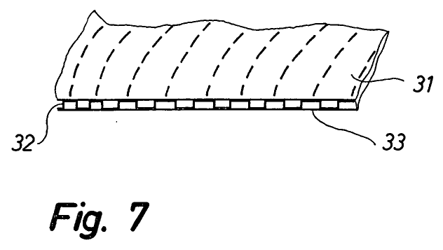

As shown in FIG. 2 the surface of each auxiliary paper layer 12 and 14 can follow a face substantially corresponding to the mathematical functional expression:

$$z ( x , y ) = a sin ( \frac{2 π}{{λ}_{1}} x + \frac{π}{2} + b sin \frac{2 π}{{λ}_{2}} y )$$

where a and λ₁ represent the amplitude and the wavelength, respectively, of the waves perpendicular to the plane of-propagation of each auxiliary paper layer 13, and where b and λ₂ represent the amplitude and the wavelength, respectively, of the waves formed by the wave tops of the above-mentioned waves and presenting an amplitude in the plane of said auxiliary paper layers 12 or 14. The expression applies to a rectilinear XYZ-coordinate system.

The ratio

$$\frac{a}{b}$$

of the amplitudes for the two types of waves can be in the range of 0.10 to 0.60, preferably 0.15 to 0.50, and especially 0.22 corresponding to a=0.5 mm and b=2.25 mm.

The ratio

$$\frac{{λ}_{1}}{{λ}_{2}}$$

of the wavelengths for the two types of waves can be in the range of 0.09 to 0.20, and preferably be approximately 0.15 corresponding to λ₁=3.5 mm and λ₂=23.5 mm.

As, far as the waves are concerned which present an amplitude a perpendicular to the direction of propagation of the auxiliary paper layers 12 and 14, a small phase displacement φ is provided between the waves of these layers, conf. FIG. 1. φ is in the range of

$$\frac{π}{4} < φ < \frac{π}{3} .$$

The plane paper layer 15 is optional.

In the auxiliary paper layers 12 and 14, at least the waves presenting an amplitude perpendicular to the plane of propagation of the packaging material may be provided with rather flat sides in such a manner that said waves are substantially serrated. The serrations can be provided with slightly rounded tops and bottoms, viz. triangularly wavy.

The waves presenting the amplitude perpendicular to the plane of propagation of the packaging material may also be substantially of a square wavy shape.

The packaging material according to the invention is advantageous in presenting a high flexural rigidity and a high capacity of absorbing impacts. In addition, the material presents a high tear resistance because the possibility of tearing up the material along the waves has been highly reduced or eliminated. Furthermore, the material is advantageous in including folding lines which are always distinct because they always continue across the ridges which is an important feature in connection with a mechanical packing of articles. The washboard effect is minimized. Furthermore, the material is very suited for being provided with a graphical print The material turned out to be particularly suited for packing plane furniture parts. Finally it should be noted that by using the packaging material according to the invention in connection with a packing machine it is possible to use the latter in a more efficient way.

Each plane paper layer can, of course, be of a weight in grammes per m², which deviates from the weight in grammes per m² of each single auxiliary paper layer.

The invention may be modified in many ways without thereby deviating from the scope of the invention.

1. A packaging material of the corrugated cardboard type made by gluing together a plane paper layer (11) and an auxiliary paper layer (12) with waves presenting an amplitude (a) perpendicular to the plane of propagation of the auxiliary paper layer, and where the wave tops form a system of substantially parallel waves (10, 10′, 10″) presenting an amplitude (b) in the plane of propagation of said auxiliary paper layer (13), a second plane paper layer (13) being arranged below said auxiliary paper layer (12), characterised in, that it comprises a second auxiliary paper layer (14) arranged below said second plane paper layer (13) and optionally a third plane paper layer (15) and in that as far as the waves are concerned which present an, amplitude perpendicular to the direction of propagation of the two auxiliary paper layers (12, 14), a phase displacement φ is provided between the waves of these layers, φ being in the range of
$$\frac{π}{4} - \frac{π}{3} .$$

2. A packaging material according to claim 1, characterised in, that the waves of at least one type of waves on the auxiliary paper layers (12, 14) are rather flat on the sides in such a manner that the waves are of a substantially serrated shape, viz. triangular waves with tops and bottoms which are optionally slightly rounded, or the waves can be substantially “square”, viz. square waves.

3. A packaging material according to claim 1, characterised in, that the surface of each auxiliary paper layer (12, 14) follows a face substantially corresponding to the mathematical functional expression:
$$z ( x , y ) = a sin ( \frac{2 π}{{λ}_{1}} x + \frac{π}{2} + b sin \frac{2 π}{{λ}_{2}} y )$$
where a and λ₁ represent the amplitude and the wavelength, respectively, of the waves perpendicular to the plane of propagation of the auxiliary paper layer, and where b and λ₂ represent the amplitude and the wavelength, respectively, of the waves in the plane of said auxiliary paper layer, viz. the plane of propagation, and that the ratio
$$\frac{a}{b}$$
of the amplitudes for the two types of waves may be in the range of 0.10 to 0.60, preferably 0.15 to 0.50, especially 0.22 corresponding to a=0.5 mm and b=2.25 mm.

4. A packaging material according to claim 1, characterised in, that the ratio
$$\frac{{λ}_{1}}{{λ}_{2}}$$
of the wavelengths for the two types of waves is in the range of 0.09 to 0.20 and preferably is approximately 0.15 corresponding to λ₁=3.5 mm and λ₂=23.5 mm.

5. A packaging material according to claim 2, characterised in, that the plane paper layers (11, 13) and the auxiliary paper layers (12, 14) are of the same thickness, preferably between 0.05 and 0.3 mm, such as 0.1 mm, and that-the auxiliary paper layers (3) is of a weight of 50 to 250 g/m²/.

6. A packaging material according to claim 1, characterised in, that starch-based or cold-water glue is used for the lamination of the layers.
